(19) United States
(12) Patent Application Publication
(10) Pub. No.: US 2025/0048260 A1
(43) Pub. Date: Feb. 6, 2025

(54) USER EQUIPMENT REQUEST FOR OPERATION STATE

(71) Applicant: QUALCOMM Incorporated, San Diego, CA (US)

(72) Inventors: Ahmed ELSHAFIE, San Diego, CA (US); Huilin XU, Temecula, CA (US); Diana MAAMARI, San Diego, CA (US)

(21) Appl. No.: 18/362,846

(22) Filed: Jul. 31, 2023

(51) Int. Cl. H04W 52/02; H04W 76/28

(52) U.S. Cl. CPC H04W 52/0209; H04W 76/28

(57) ABSTRACT

Various aspects of the present disclosure generally relate to wireless communication. In some aspects, a user equipment (UE) may select a UE operation state that is either a reduced power state or a non-reduced power state. The UE may transmit a request to enter the UE operation state. Numerous other aspects are described.

### FIELD OF THE DISCLOSURE

Aspects of the present disclosure generally relate to wireless communication and to techniques and apparatuses for requesting an operation state.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include selecting a UE operation state that is either a reduced power state or a non-reduced power state. The method may include transmitting a request to enter the UE operation state.

Some aspects described herein relate to a method of wireless communication performed by a network entity. The method may include receiving a request for a UE to enter a UE operation state that is either a reduced power state or a non-reduced power state. The method may include transmitting an indication to enter the UE operation state or an adjusted UE operation state based at least in part on the request.

Some aspects described herein relate to a UE for wireless communication. The UE may include one or more memories and one or more processors coupled to the one or more memories. The one or more processors may be configured to select a UE operation state that is either a reduced power state or a non-reduced power state. The one or more processors may be configured to transmit a request to enter the UE operation state.

Some aspects described herein relate to a network entity for wireless communication. The network entity may include one or more memories and one or more processors coupled to the one or more memories. The one or more processors may be configured to receive a request for a UE to enter a UE operation state that is either a reduced power state or a non-reduced power state. The one or more processors may be configured to transmit an indication to enter the UE operation state or an adjusted UE operation state based at least in part on the request.

Some aspects described herein relate to a non-transitory computer-readable medium that stores a set of instructions for wireless communication by a UE. The set of instructions, when executed by one or more processors of the UE, may cause the UE to select a UE operation state that is either a reduced power state or a non-reduced power state. The set of instructions, when executed by one or more processors of the UE, may cause the UE to transmit a request to enter the UE operation state.

Some aspects described herein relate to a non-transitory computer-readable medium that stores a set of instructions for wireless communication by a network entity. The set of instructions, when executed by one or more processors of the network entity, may cause the network entity to receive a request for a UE to enter a UE operation state that is either a reduced power state or a non-reduced power state. The set of instructions, when executed by one or more processors of the network entity, may cause the network entity to transmit an indication to enter the UE operation state or an adjusted UE operation state based at least in part on the request.

Some aspects described herein relate to an apparatus for wireless communication. The apparatus may include means for selecting an operation state that is either a reduced power state or a non-reduced power state. The apparatus may include means for transmitting a request to enter the operation state.

Some aspects described herein relate to an apparatus for wireless communication. The apparatus may include means for receiving a request for another apparatus to enter an operation state that is either a reduced power state or a non-reduced power state. The apparatus may include means for transmitting an indication to enter the operation state or an adjusted operation state based at least in part on the request.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example associated with requesting a UE operation state, in accordance with the present disclosure.

FIG. 5 is a diagram illustrating an example of UE operation state request resources, in accordance with the present disclosure.

FIG. 6 is a diagram illustrating an example process performed, for example, at a UE or an apparatus of a UE, in accordance with the present disclosure.

FIG. 7 is a diagram illustrating an example process performed, for example, at a network entity or an apparatus of a network entity, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

Various aspects relate generally to wireless communication and more particularly to energy conservation. A user equipment (UE) may seek to conserve energy by entering a reduced power state that uses less power than a non-reduced power state (e.g., operates at full power or capabilities). A reduced power state may include for example, a sleep state, a discontinuous reception (DRX) mode that includes periodic DRX cycles (where each DRX cycle includes an active duration during which the UE uses power for monitoring and reception and an inactive duration during which the UE reduces its power and does not monitor for and receive signals), a secondary cell dormancy state, or a communication skipping state that skips communications in transmission or reception occasions. While a UE may enter a reduced power state, the UE may do so by instruction from a network entity. The UE lacks flexibility for entering and exiting a reduced power state. The lack of flexibility may cause the UE to consumer more power than necessary.

According to various aspects described herein, a UE may request a UE operation state. The UE may request to enter a reduced power state or to enter a non-reduced power state (exit a reduced power state). A network entity may accept or reject the request. If the network entity accepts the request, the network entity may transmit an instruction to the UE to enter the reduced power state or the non-reduced power state. In some aspects, the network entity may adjust the reduced power state. If the UE is in a reduced power state, the UE may be granted sufficient resources to be able to transmit a request to exit the reduced power state and to enter the non-reduced power state.

Particular aspects of the subject matter described in this disclosure can be implemented to realize one or more of the following potential advantages. In some examples, by providing the UE the ability to request and be granted a UE operation state, the UE may have more flexibility to enter and exit a reduced power state, as the UE may have earlier information about its energy status (e.g., battery level, energy harvesting rate, energy usage, channel conditions at the UE, and/or traffic conditions at the UE, among other examples) than the network entity. As a result, the UE may conserve more power or improve communications as determined by the UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

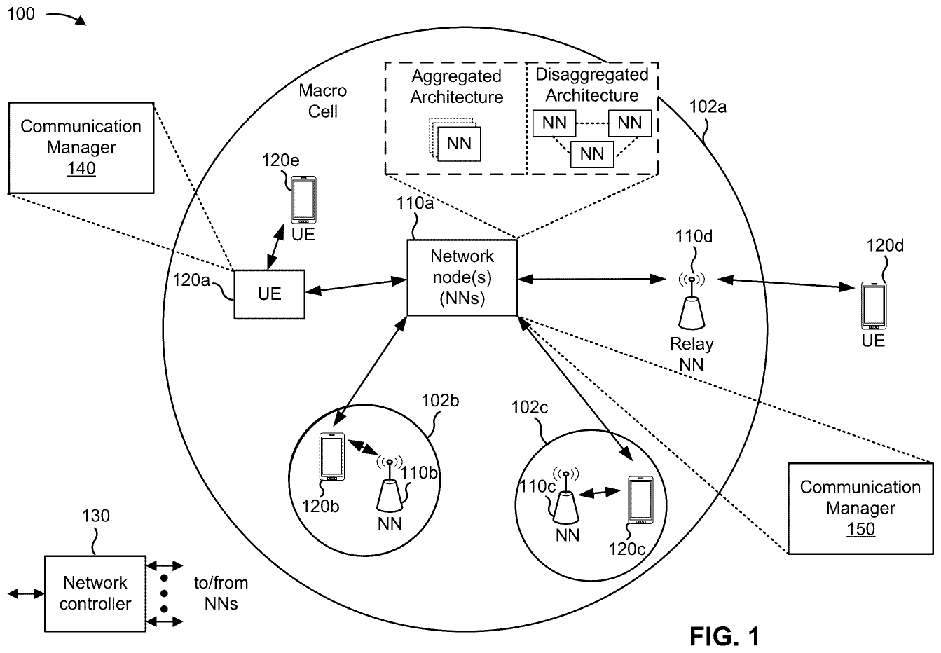

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., a UE 120) may include a communication manager 140. As described in more detail elsewhere herein, the communication manager 140 may select a UE operation state that is either a reduced power state or a non-reduced power state. The communication manager 140 may transmit a request to enter the UE operation state. Additionally, or alternatively, the communication manager 140 may perform one or more other operations described herein.

In some aspects, a network entity (e.g., network node 110) may include a communication manager 150. As described in more detail elsewhere herein, the communication manager 150 may receive a request for a UE to enter a UE operation state that is either a reduced power state or a non-reduced power state. The communication manager 150 may transmit an indication to enter the UE operation state or an adjusted UE operation state based at least in part on the request. Additionally, or alternatively, the communication manager 150 may perform one or more other operations described herein.

As indicated above, FIG. 1 is provided as an example. Other examples may differ from what is described with regard to FIG. 1.

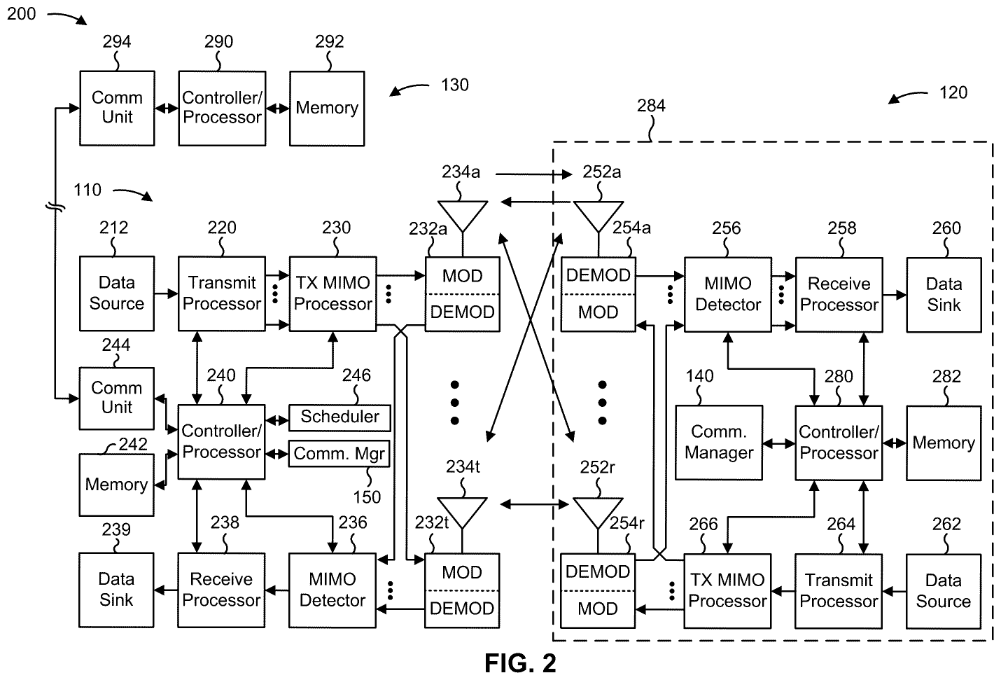

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

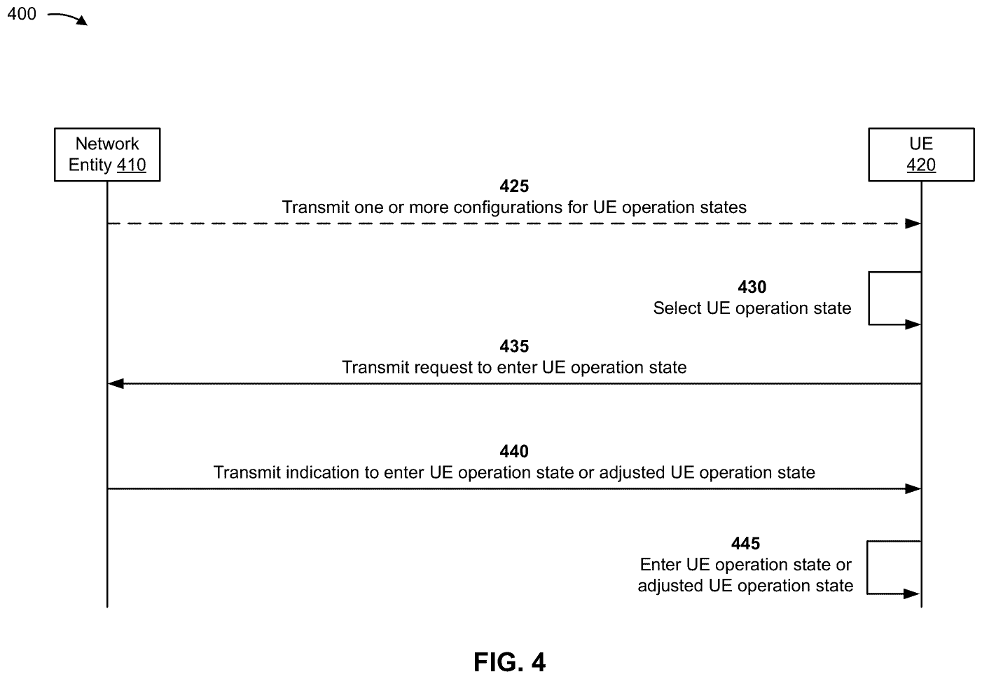

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-9).

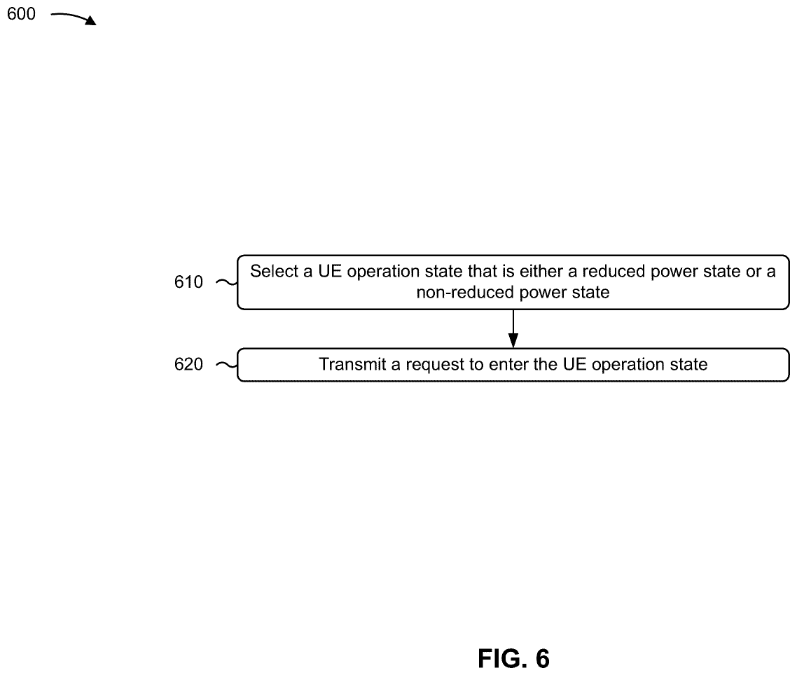

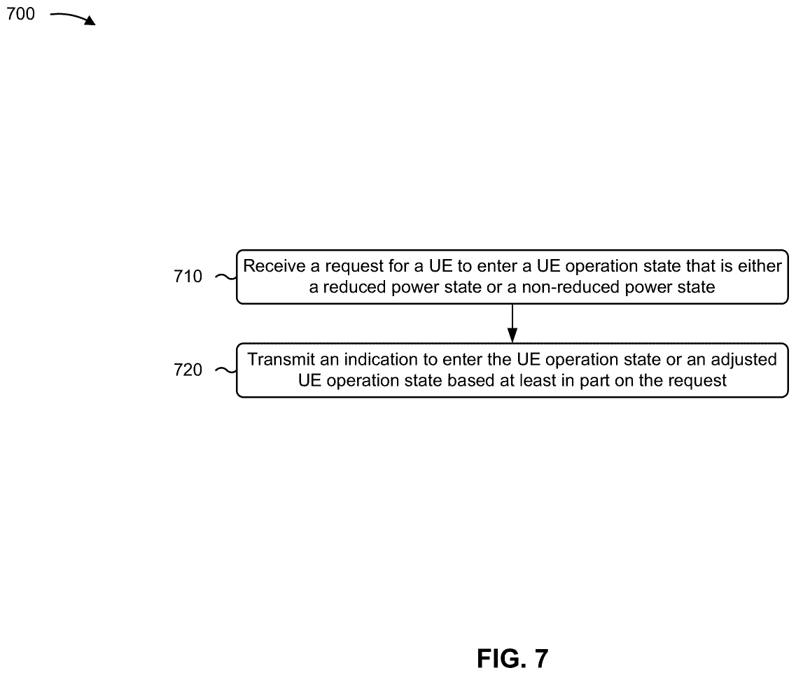

A controller/processor of a network entity (e.g., controller/processor 240 of the network node 110), the controller/processor 280 of the UE 120, and/or any other component(s) of FIG. 2 may perform one or more techniques associated with a UE requesting a UE operation state, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a UE (e.g., a UE 120) includes means for selecting a UE operation state that is either a reduced power state or a non-reduced power state; and/or means for transmitting a request to enter the UE operation state. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., a network node 110) includes means for receiving a request for a UE to enter a UE operation state that is either a reduced power state or a non-reduced power state; and/or means for transmitting an indication to enter the UE operation state or an adjusted UE operation state based at least in part on the request. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

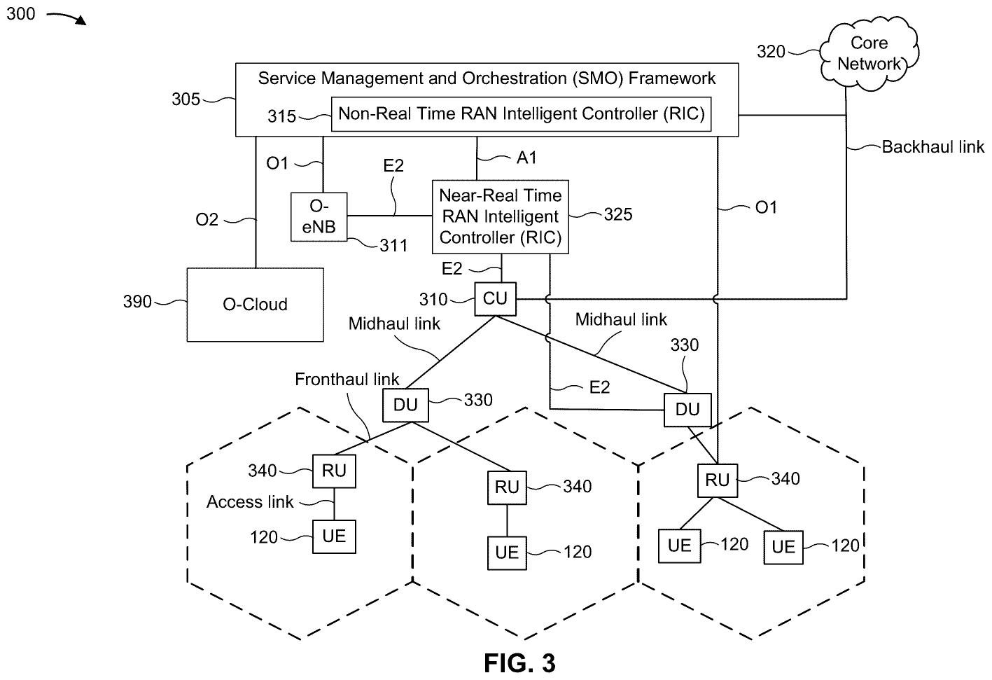

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-ENB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

UEs may be from different categories of different capabilities. For example, a network node may serve a first category of UEs that have a less advanced capability (e.g., a lower capability and/or a reduced capability) and a second category of UEs that have a more advanced capability (e.g., a higher capability). A UE of the first category may have a reduced feature set compared to UEs of the second category, and may be referred to as a reduced capability (RedCap) UE, a low tier UE, NR-Light UE, and/or an NR-Lite UE, among other examples. UEs of the first category may be, for example, industrial wireless sensors, low-end smartphones, health monitors, video surveillance, high-end wearables, MTC devices, and/or high-end logistic trackers.

A UE of the second category may have an advanced feature set compared to UEs of the first category, and may be referred to as a baseline UE, a high tier UE, an NR UE, and/or a premium UE, among other examples. UEs of the second category may include enhanced mobile broadband (eMBB) devices, ultra-reliable low latency communication (URLLC) devices, extended reality (XR) devices, laptops, robots, industrial machines, and/or high-end smartphones. UEs of the first category may support a lower maximum MCS than UEs of the second category (e.g., quadrature phase shift keying (QPSK) or the like as compared to 256-quadrature amplitude modulation (QAM) or the like), may support a lower maximum transmit power than UEs of the second category, may have a less advanced beamforming capability than UEs of the second category (e.g., may not be capable of forming as many beams as UEs of the second category), may require a longer processing time than UEs of the second category, may include less hardware than UEs of the second category (e.g., fewer antennas, fewer transmit antennas, and/or fewer receive antennas), and/or may not be capable of communicating on as wide of a maximum bandwidth part as UEs of the second category, among other examples. Additionally, or alternatively, UEs of the second category may be capable of communicating using a shortened transmission time interval (TTI) (e.g., a slot length of 1 ms or less, 0.5 ms, 0.25 ms, 0.125 ms, 0.0625 ms, or the like, depending on a sub-carrier spacing), and UEs of the first category may not be capable of communicating using the shortened TTI.

There may be a third category of devices that may be referred to as enhanced RedCap (eRedCap) devices or NR-Superlight devices. Such devices may include eMTC devices and/or NB-IoT devices in association with 3GPP Release 18 and/or massive IoT. UEs of the third category may include, for example, low-end industrial sensors, parking sensors, agricultural sensors, utility meters, low-end wearables, and/or low-end asset trackers. Just as UE capabilities of the first category differ from UE capabilities of the second category. UE capabilities of the third category may differ from UE capabilities of the first category and the second category.

In some examples, to conserve power, a UE (e.g., of the first or third category) may enter a reduced power state that uses less power than a non-reduced power state. The reduced power state may include a dormant state that disables certain uplink and downlink activities. The reduced power state may include a sleep state. Sleeping may involve turning off a radio and one or more other components or functions. Turning off or switching off a radio may include removing power from the radio such that the radio is not fully operating or not operating with full power. The UE may wake up for an active duration. Waking up may involve turning on a radio and one or more other components or functions. Turning on or switching on a radio may include adding power to the radio such that the radio is fully operating or operating with full power. The reduced power state may be part of a DRX mode that includes periodic DRX cycles, where each DRX cycle includes an active duration during which the UE uses power for monitoring and reception and an inactive duration during which the UE reduces its power and does not monitor for and receive signals (or does not receive certain signals). The reduced power state may include a secondary cell dormancy state, where communications using a secondary cell are stopped. The reduced power state may include disabling the use of a channel or the limited support of a PHY channel. The reduced power state may include limited support for Layer 1 (L1), Layer 2 (L2), or Layer 3 (L3) signaling.

In some examples, the reduced power state may include physical downlink control channel (PDCCH) or physical downlink shared channel (PDSCH) skipping, where the UE skips monitoring for downlink communications in downlink slots, downlink symbols, scheduled monitoring occasions, or certain formats (but does not skip certain downlink control information (DCI) formats or energy control signals). The reduced power state may include physical uplink control channel (PUCCH) or physical uplink shared channel (PUSCH) skipping, where the UE skips uplink communications in uplink slots, uplink symbols or scheduled transmission occasions. The reduced power state may include switching to a search space set group (SSSG) that uses less power. The reduced power state may include following a pattern of activity for reduced communications, a pattern of skipping, or a pattern of a combination of skipping and using the SSSG.

In some examples, the reduced power state may be associated with a specific RRC configuration for conserving power. The reduced power state may use a restrictive time gap or timeline between various signals based on at least a bandwidth, a quantity of resource elements (REs), or a type of signal (e.g., reference signal or synchronization signal).

While a UE may enter a reduced power state, the UE may do so at the instruction of a network entity. The UE lacks flexibility for entering and exiting a reduced power state. The lack of flexibility may cause the UE to consumer more power than necessary.

FIG. 4 is a diagram illustrating an example 400 associated with requesting a UE operation state, in accordance with the present disclosure. As shown in FIG. 4, a network entity 410 (e.g., network node 110) and a UE 420 (e.g., UE 120) may communicate with one another via a wireless network (e.g., wireless network 100).

According to various aspects described herein, a UE may request a UE operation state. The UE may request to enter a reduced power state or to enter a non-reduced power state (exit a reduced power state). A network entity may transmit a response that accepts the request or rejects the request. If the request is accepted, the network entity may transmit an instruction to the UE to enter the reduced power state or the non-reduced power state. In some aspects, the network entity may adjust the reduced power state. If the UE is in a reduced power state, the UE may be granted sufficient resources to be able to transmit a request to exit the reduced power state and to enter the non-reduced power state. By providing the UE the ability to request and be granted a UE operation state, the UE may have more flexibility to enter and exit a reduced power state, as the UE may have earlier information about its energy status (e.g., battery level, energy harvesting rate, energy usage, channel conditions at the UE, and/or traffic conditions at the UE, among other examples) than the network entity. As a result, the UE may conserve more power or improve communications as determined by the UE.

Example 400 shows the UE 420 requesting a UE operation state. As shown by reference number 425, the network entity 410 may transmit one or more configurations of UE operation states (e.g., via RRC signaling). This may be optional. Each configuration may be associated with a list of allowed UE operation states, behaviors, or RRC configurations. The current state and the network entity 410 may trigger or activate multiple configurations (e.g., via DCI or a MAC CE). In some aspects, each configuration may include multiple resources, and the UE 420 may use one of the resources. The resource may be associated with list of allowed UE operation states, behaviors, or RRC configurations.

As shown by reference number 425, the UE 420 may select the UE operation state. The UE operation state may be a reduced power state or a non-reduced power state (to exit a reduced power state). The UE 420 may select the UE operation state based at least in part on an energy status of the UE 420 (e.g., energy level and/or energy harvesting rate is lower than a threshold, energy level and/or energy harvesting rate is higher than a threshold, energy usage is higher or lower than a threshold), channel conditions at the UE 420 (e.g., interference on channel or channel clear), and/or traffic conditions at the UE 420 (e.g., an increase in traffic, a decrease in traffic). For example, the UE 420 may select a reduced power state if the energy level drops below an energy level threshold and/or the energy harvesting rate drops below a harvesting threshold. In another example, the UE 420 may select a non-reduced power state if the energy level is above the energy level threshold and traffic to be transmitted rises above a traffic threshold.

As shown by reference number 430, the UE 420 may transmit a request to enter the selected UE operation state. In some aspects, the request may include one or more bits in a field (e.g., flag, StateChangeRequestIndicator) that indicate a request to remain in the same UE operation state, a request to switch to a first new UE operation state, or a request to switch to a second new UE operation state. In some aspects, the UE 420 may select a configuration from among the multiple configurations. The configuration may be used to indicate or enter the selected UE operation state. The UE 420 may indicate the configuration as part of the request.

In some aspects, the network entity 410 may accept the request. The UE 420 may be power limited and the network entity may not know the energy status of the UE 420. In some aspects, the network entity 410 may also adjust the UE operation state. For example, the network entity 410 may change the UE operation state that is requested to another type of UE operation state or adjust a parameter (e.g., duration) for the requested UE operation state. The network entity 410 may indicate a change associated with a reduced power state such as a change to a communication state, an RRC configuration, an SSSG switch/state, PDCCH skipping, disablement of channels or signals, a sequence or pattern, or an activity. As shown by reference number 435, the network entity 410 may transmit an indication to enter the UE operation state or an adjusted UE operation state. In some aspects, the indication may be used to activate a selected configuration. Alternatively, the network entity 410 may reject the request and no indication is transmitted.

In some aspects, the indication to enter the UE operation state may include one or more bits (e.g., StateChangeIndicator), where a bit value of 0 (zero) indicates that there is no change to a UE operation state and a bit value of 1 indicates that the UE 420 is to switch to another UE operation state. If there is no bits in an indicator field, the UE 420 may remain in a current UE operation state. In some aspects, a bit value of 0 indicates that the UE 420 is to enter a first UE operation state and a bit value of 1 indicates that the UE 420 is to enter a second UE operation state. The bits may cancel or extend a reduced power state.

In some aspects, the UE 420 may transmit the request in multiple stages (e.g., a first stage and a second stage). In some aspects, the indication may be included in multiple stages, where a bit value of 0 in a first stage indicates that the UE 420 is to switch to or toggle a UE operation state and a bit value of 1 indicates that the UE 420 is to wait for a second stage that will indicate the UE operation state. No bits in an indicator field may indicate that the UE 420 is to remain in a current state. In another example, a bit value of 0 indicates that the UE 420 is to remain in the same UE operation state and a bit value of 1 indicates that more details are to come in a second stage.

In some aspects, multiple stages may be used for a request. In some aspects, the network entity 410 may use a first indication in a first stage to indicate a set of uplink transmission occasions (where an uplink occasion includes one or more of resource sets and where a resource set includes resources that can be used for transmission). The set of uplink transmission occasions indicated in the first stage may be activated using a second stage. The UE 420 may use any of the second stage occasions for a request for a UE operation state. The network entity 410 may then transmit an indication to activate the requested UE operation state. An indication in the second stage occasion may be included in L1, L2 or L3 signals, such as uplink control information (UCI) in PUCCH or PUSCH, a MAC control element (MAC CE), an RRC message, or user assistance information (UAI) after the first stage. The second stage occasions may be within a period or duration for a reduced power state.

In some aspects, there may be multiple bits that indicate a UE operation state or a request for a UE operation state. For example, bits 00 may indicate that the UE 420 is to remain in the same UE operation state. Bits 01 may indicate that the UE 420 is to switch to a UE operation state (e.g., energy or communicate state X or SSSG X, cancel PDCCH skipping, extend PDCCH skipping by duration X or use RRC configuration X). Bits 10 or 11 may indicate that the UE 420 is to switch to a

As shown by reference number 440, the UE 420 may UE operation state (e.g., energy or communicate state Y or SSSG Y, cancel PDCCH skipping, extend PDCCH skipping by duration Y or use RRC configuration Y). enter the UE operation state or the adjusted UE operation state that is indicated. In some aspects, as part of the indication, the network entity 410 may indicate a set of resources for a UE operation state request. For example, the network entity 410 may activate a set of uplink transmission occasions that can be used for sending future UE operation state requests. The set of uplink transmission occasions may be within a communication skipping period or another period of a reduced power state. The UE 420 may use one or more of the uplink transmission occasions based at least in part on satisfying one or more conditions. The conditions may involve an energy status of the UE 420 being above or below an energy status threshold, traffic conditions being above or below a traffic threshold, and/or a channel condition being above or below a channel quality threshold.

In some aspects, a UE operation state may be one UE operation state out of a list of UE operation states (e.g., configured via RRC signaling). The network entity 410 and/or a current UE operation state may trigger the UE operation state or can trigger multiple UE operation states or configurations (e.g., via DCI or a MAC CE). In some aspects, each UE operation state or configuration may be associated with multiple resources. The UE 420 may use one of the resources to transmit a request or for the UE operation state. The resource may be associated with a list of UE operation states, such as a list of allowed UE operation states, behaviors, or RRC configurations. The current state and the network entity 410 may activate multiple configurations. In sum, there may be various ways to request and indicate a UE operation state. This provides additional flexibility to the network entity 410 and the UE 420.

As indicated above, FIG. 4 is provided as an example. Other examples may differ from what is described with respect to FIG. 4.

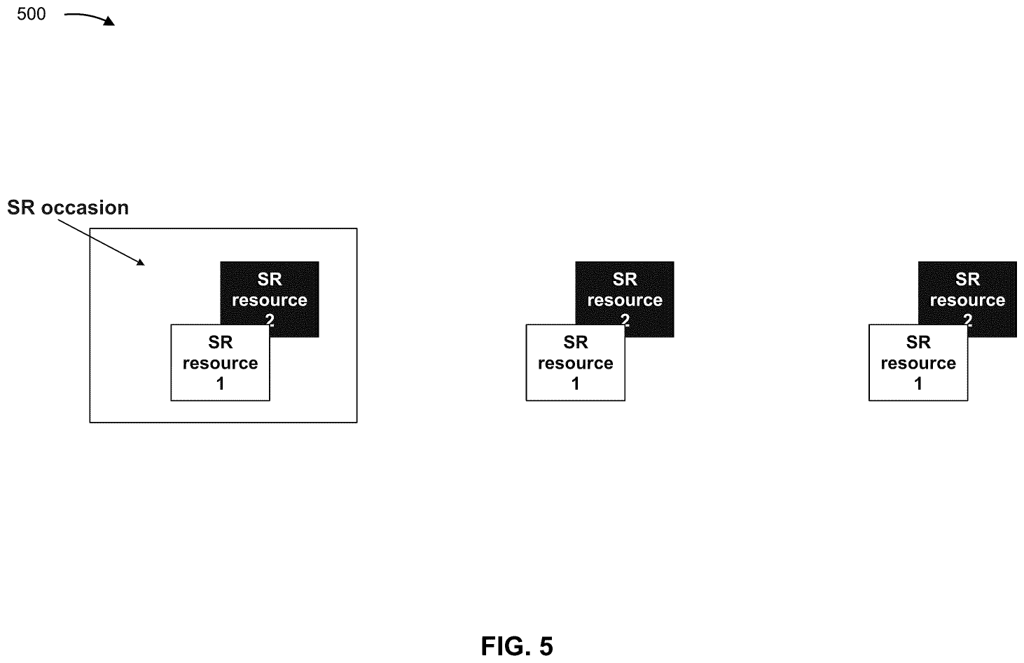

FIG. 5 is a diagram illustrating an example 500 of UE operation state request resources, in accordance with the present disclosure.

Example 500 shows multiple scheduling request (SR) occasions, with multiple SR resources (e.g., SR resource 1, SR resource 2) in each SR occasion. In some aspects, the network entity 410 may activate extra resources per SR occasion after a UE operation state change and based at least in part on the UE operation states that are available. In some aspects, the indication of the UE operation state may include an SR indication that enables a second stage by default or by using more bits in an SR or more resources. For example, SR resources 2 may be activated only during a new UE operation state or during PDCCH skipping. A selected resource may indicate both an SR and new state information, as necessary.

In some aspects, each SR occasion may be associated with up to a specified quantity of UE operations states or configurations (e.g., 8 if the next stage is indicated by a MAC CE). The UE operation states may have different SR configurations. In some aspects, there may be a sub-configuration or behavior per UE operation state. The UE 420 may request the sub-configuration or behavior. If the UE 420 can support only one UE operation state, the UE 420 may include the UE operation state identifier (ID) and an allowed configuration per UE operation state.

Currently, an SR value of 0 is not used. The UE 420 may either transmit a positive SR as SR=1 (UE has a buffer status report (BSR) and is to schedule an uplink transmission) or a negative SR as no change. In some aspects, since SR=0 is not currently used, the UE 420 may use specific SR occasions and/or a specific SR configuration. The network entity 410 may define multiple SR resources per occasion where the UE 420 can use SR=0 or SR=1 to request a UE operation state. In some aspects, the UE 420 may have a second resource instead of a default resource. When the UE 420 is expected to indicate an SR only, the UE 420 may transmit SR=0 in the default resource. The UE 420 may allow for SR blind decoding at the network entity 410 to increase the quantity of delivered bits. In some aspects, a timer may be started that prohibits the UE 420 from transmitting another SR during the timer (to allow for encoding).

As indicated above, FIG. 5 is provided as an example. Other examples may differ from what is described with regard to FIG. 5.

FIG. 6 is a diagram illustrating an example process 600 performed, for example, at a UE or an apparatus of a UE, in accordance with the present disclosure. Example process 600 is an example where the apparatus or the UE (e.g., UE 120, UE 420) performs operations associated with UE request for a UE operation state.

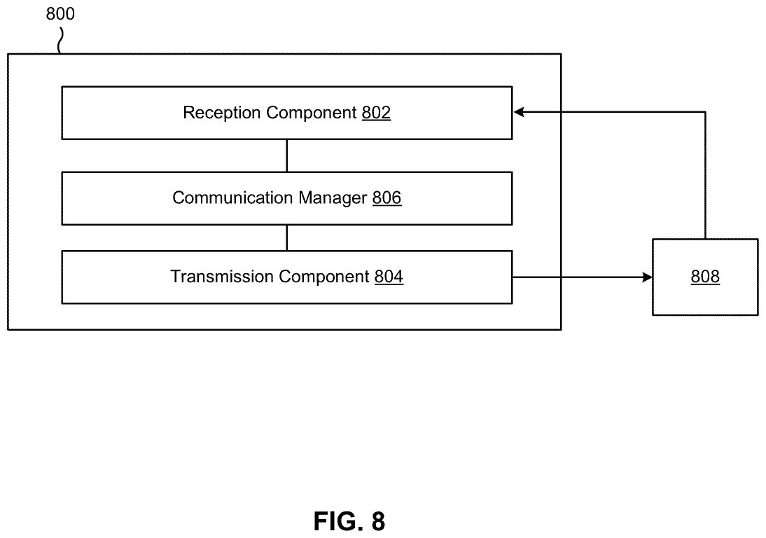

As shown in FIG. 6, in some aspects, process 600 may include selecting a UE operation state that is either a reduced power state or a non-reduced power state (block 610). For example, the UE (e.g., using communication manager 806, depicted in FIG. 8) may select a UE operation state that is either a reduced power state or a non-reduced power state, as described above.

As further shown in FIG. 6, in some aspects, process 600 may include transmitting a request to enter the UE operation state (block 620). For example, the UE (e.g., using transmission component 804 and/or communication manager 806, depicted in FIG. 8) may transmit a request to enter the UE operation state, as described above.

Process 600 may include additional aspects, such as any single aspect or any combination of aspects described below and/or in connection with one or more other processes described elsewhere herein.

In a first aspect, process 600 includes receiving an indication to enter the UE operation state based at least in part on the request and entering the UE operation state based at least in part on the indication.

In a second aspect, alone or in combination with the first aspect, process 600 includes receiving an indication to enter an adjusted UE operation state based at least in part on the request and entering the adjusted UE operation state based at least in part on the indication.

In a third aspect, alone or in combination with one or more of the first and second aspects, the reduced power state is associated with skipping uplink or downlink signals, skipping monitoring of physical downlink control channel communications, disabling use of a channel, DRX, or a switch to a search space set group for saving power.

In a fourth aspect, alone or in combination with one or more of the first through third aspects, the reduced power state is configured with resources to transmit a new request to enter a new UE operation state.

In a fifth aspect, alone or in combination with one or more of the first through fourth aspects, the UE operation state is associated with a set of uplink transmission occasions.

In a sixth aspect, alone or in combination with one or more of the first through fifth aspects, the UE operation state is used for an uplink transmission occasion based at least in part on a specified condition.

In a seventh aspect, alone or in combination with one or more of the first through sixth aspects, the request includes one or more bits that indicate to remain in a same UE operation state, switch to a first new UE operation state, or switch to a second new operation state.

In an eighth aspect, alone or in combination with one or more of the first through seventh aspects, the request includes one or more bits that indicate to cancel or extend a reduced power state.

In a ninth aspect, alone or in combination with one or more of the first through eighth aspects, transmitting the request includes transmitting the request in multiple transmission stages.

In a tenth aspect, alone or in combination with one or more of the first through ninth aspects, selecting the UE operation state includes selecting a set of UE operation states, and the request includes the set of operation states.

In an eleventh aspect, alone or in combination with one or more of the first through tenth aspects, the request indicates a resource that is associated with the set of UE operation states.

In a twelfth aspect, alone or in combination with one or more of the first through eleventh aspects, the UE operation state is associated with a set of resources for an SR.

In a thirteenth aspect, alone or in combination with one or more of the first through twelfth aspects, the UE operation state is one of multiple UE operation states, each UE operation state being associated with one or more resources.

In a fourteenth aspect, alone or in combination with one or more of the first through thirteenth aspects, the request is indicated by an SR value.

In a fifteenth aspect, alone or in combination with one or more of the first through fourteenth aspects, process 600 includes disabling a prohibitive timer for SRs.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network entity or an apparatus of a network entity, in accordance with the present disclosure. Example process 700 is an example where the apparatus or the network entity (e.g., network node 110, network entity 410) performs operations associated with a indicating a UE operation state based in a UE request.

As shown in FIG. 7, in some aspects, process 700 may include receiving a request for a UE to enter a UE operation state that is either a reduced power state or a non-reduced power state (block 710). For example, the network entity (e.g., using reception component 902 and/or communication manager 9) may receive a request for a UE to enter a UE operation state that is either a reduced power state or a non-reduced power state, as described above.

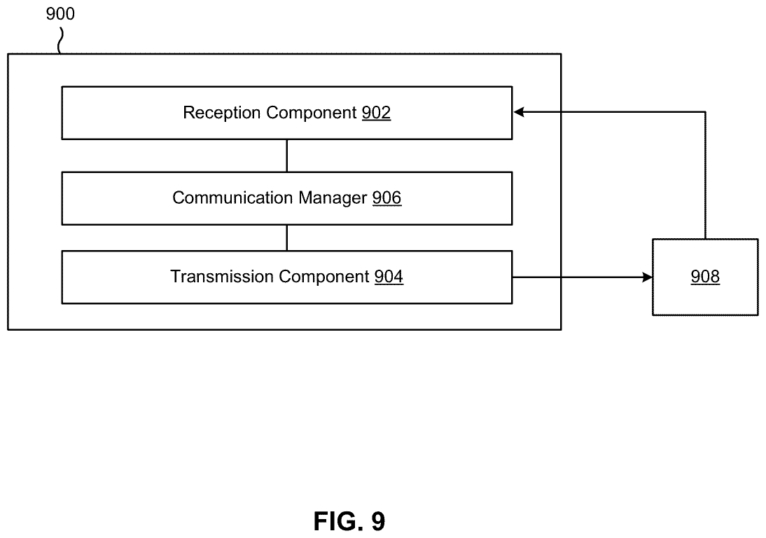

As further shown in FIG. 7, in some aspects, process 700 may include transmitting an indication to enter the UE operation state or an adjusted UE operation state based at least in part on the request (block 720). For example, the network entity (e.g., using transmission component 904 and/or communication manager 906, depicted in FIG. 9) may transmit an indication to enter the UE operation state or an adjusted UE operation state based at least in part on the request, as described above.

Process 700 may include additional aspects, such as any single aspect or any combination of aspects described below and/or in connection with one or more other processes described elsewhere herein.

In a first aspect, the UE operation state is associated with a set of uplink transmission occasions.

In a second aspect, alone or in combination with the first aspect, the indication includes one or more bits that indicate to remain in a same UE operation state, switch to a first new UE operation state, or switch to a second new operation state.

In a third aspect, alone or in combination with one or more of the first and second aspects, the indication includes one or more bits that indicate to cancel or extend a reduced power state.

In a fourth aspect, alone or in combination with one or more of the first through third aspects, receiving the request includes receiving the request in multiple transmission stages.

In a fifth aspect, alone or in combination with one or more of the first through fourth aspects, the UE operation state includes a set of UE operation states, and the indication indicates one or more UE operation states.

In a sixth aspect, alone or in combination with one or more of the first through fifth aspects, the request indicates a resource that is associated with the set of UE operation states, and the indication indicates the resource.

In a seventh aspect, alone or in combination with one or more of the first through sixth aspects, the UE operation state is associated with a set of resources for an SR.

In an eighth aspect, alone or in combination with one or more of the first through seventh aspects, the UE operation state is one of multiple UE operation states, each UE operation state being associated with one or more resources.

In a ninth aspect, alone or in combination with one or more of the first through eighth aspects, the request is indicated by an SR value.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE (e.g., UE 120, UE 420), or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 1-5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 804 may be co-located with the reception component 802 in one or more transceivers.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The communication manager 806 may select a UE operation state that is either a reduced power state or a non-reduced power state. The transmission component 804 may transmit a request to enter the UE operation state.

The reception component 802 may receive an indication to enter the UE operation state based at least in part on the request. The communication manager 806 may enter the UE operation state based at least in part on the indication.

The reception component 802 may receive an indication to enter an adjusted UE operation state based at least in part on the request. The communication manager 806 may enter the adjusted UE operation state based at least in part on the indication. The communication manager 806 may disable a prohibitive timer for SRs.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network entity (e.g., network node 110, network entity 410), or a network entity may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 1-5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network entity described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the network entity described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, one or more modems, one or more modulators, one or more transmit MIMO processors, one or more transmit processors, one or more controllers/processors, one or more memories, or a combination thereof, of the network entity described in connection with FIG. 2. In some aspects, the transmission component 904 may be co-located with the reception component 902 in one or more transceivers.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive a request for a UE to enter a UE operation state that is either a reduced power state or a non-reduced power state. The transmission component 904 may transmit an indication to enter the UE operation state or an adjusted UE operation state based at least in part on the request.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: selecting a UE operation state that is either a reduced power state or a non-reduced power state; and transmitting a request to enter the UE operation state.

Aspect 2: The method of Aspect 1, further comprising: receiving an indication to enter the UE operation state based at least in part on the request; and entering the UE operation state based at least in part on the indication.

Aspect 3: The method of Aspect 1, further comprising: receiving an indication to enter an adjusted UE operation state based at least in part on the request; and entering the adjusted UE operation state based at least in part on the indication.

Aspect 4: The method of any of Aspects 1-3, wherein the reduced power state is associated with skipping uplink or downlink signals, skipping monitoring of physical downlink control channel communications, disabling use of a channel, discontinuous reception, or a switch to a search space set group for saving power.

Aspect 5: The method of any of Aspects 1-4, wherein the reduced power state is configured with resources to transmit a new request to enter a new UE operation state.

Aspect 6: The method of any of Aspects 1-5, wherein the UE operation state is associated with a set of uplink transmission occasions.

Aspect 7: The method of any of Aspects 1-6, wherein the UE operation state is used for an uplink transmission occasion based at least in part on a specified condition.

Aspect 8: The method of any of Aspects 1-7, wherein the request includes one or more bits that indicate to remain in a same UE operation state, switch to a first new UE operation state, or switch to a second new operation state.

Aspect 9: The method of any of Aspects 1-8, wherein the request includes one or more bits that indicate to cancel or extend a reduced power state.

Aspect 10: The method of any of Aspects 1-9, wherein transmitting the request includes transmitting the request in multiple transmission stages.

Aspect 11: The method of any of Aspects 1-10, wherein selecting the UE operation state includes selecting a set of UE operation states, and wherein the request includes the set of operation states.

Aspect 12: The method of Aspect 11, wherein the request indicates a resource that is associated with the set of UE operation states.

Aspect 13: The method of any of Aspects 1-12, wherein the UE operation state is associated with a set of resources for a scheduling request.

Aspect 14: The method of any of Aspects 1-13, wherein the UE operation state is one of multiple UE operation states, each UE operation state being associated with one or more resources.

Aspect 15: The method of any of Aspects 1-14, wherein the request is indicated by a scheduling request value.

Aspect 16: The method of Aspect 15, further comprising disabling a prohibitive timer for scheduling requests.

Aspect 17: A method of wireless communication performed by a network entity, comprising: receiving a request for a user equipment (UE) to enter a UE operation state that is either a reduced power state or a non-reduced power state; and transmitting an indication to enter the UE operation state or an adjusted UE operation state based at least in part on the request.

Aspect 18: The method of Aspect 17, wherein the UE operation state is associated with a set of uplink transmission occasions.

Aspect 19: The method of any of Aspects 17-18, wherein the indication includes one or more bits that indicate to remain in a same UE operation state, switch to a first new UE operation state, or switch to a second new operation state.

Aspect 20: The method of any of Aspects 17-19, wherein the indication includes one or more bits that indicate to cancel or extend a reduced power state.

Aspect 21: The method of any of Aspects 17-20, wherein receiving the request includes receiving the request in multiple transmission stages.

Aspect 22: The method of any of Aspects 17-21, wherein the UE operation state includes a set of UE operation states, and wherein the indication indicates one or more UE operation states.

Aspect 23: The method of Aspect 22, wherein the request indicates a resource that is associated with the set of UE operation states, and wherein the indication indicates the resource.

Aspect 24: The method of any of Aspects 17-23, wherein the UE operation state is associated with a set of resources for scheduling request.

Aspect 25: The method of any of Aspects 17-24, wherein the UE operation state is one of multiple UE operation states, each UE operation state being associated with one or more resources.

Aspect 26: The method of any of Aspects 17-25, wherein the request is indicated by a scheduling request value.

Aspect 27: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-26.

Aspect 28: An apparatus for wireless communication at a device, the apparatus comprising one or more memories and one or more processors coupled to the one or more memories, the one or more processors configured to cause the device to perform the method of one or more of Aspects 1-26.

Aspect 29: An apparatus for wireless communication, the apparatus comprising at least one means for performing the method of one or more of Aspects 1-26.

Aspect 30: A non-transitory computer-readable medium storing code for wireless communication, the code comprising instructions executable by one or more processors to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

Aspect 32: A device for wireless communication, the device comprising a processing system that includes one or more processors and one or more memories coupled with the one or more processors, the processing system configured to cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, individually and collectively configured to cause the UE to:
select a UE operation state that is either a reduced power state or a non-reduced power state; and
transmit a request to enter the UE operation state.

2. The UE of claim 1, wherein the one or more processors are individually and collectively configured to cause the UE to:
receive an indication to enter the UE operation state based at least in part on the request; and
enter the UE operation state based at least in part on the indication.

3. The UE of claim 1, wherein the one or more processors are individually and collectively configured to cause the UE to:
receive an indication to enter an adjusted UE operation state based at least in part on the request; and
enter the adjusted UE operation state based at least in part on the indication.

4. The UE of claim 1, wherein the reduced power state is associated with skipping uplink or downlink signals, skipping monitoring of physical downlink control channel communications, disabling use of a channel, discontinuous reception, or a switch to a search space set group for saving power.

5. The UE of claim 1, wherein the reduced power state is configured with resources to transmit a new request to enter a new UE operation state.

6. The UE of claim 1, wherein the UE operation state is associated with a set of uplink transmission occasions.

7. The UE of claim 1, wherein the UE operation state is used for an uplink transmission occasion based at least in part on a specified condition.

8. The UE of claim 1, wherein the request includes one or more bits that indicate to remain in a same UE operation state, switch to a first new UE operation state, or switch to a second new operation state.

9. The UE of claim 1, wherein the request includes one or more bits that indicate to cancel or extend a reduced power state.

10. The UE of claim 1, wherein the one or more processors, to transmit the request, are individually and collectively configured to cause the UE to transmit the request in multiple transmission stages.

11. The UE of claim 1, wherein the one or more processors, to select the UE operation state, are individually and collectively configured to select a set of UE operation states, and wherein the request includes the set of operation states.

12. The UE of claim 11, wherein the request indicates a resource that is associated with the set of UE operation states.

13. The UE of claim 1, wherein the UE operation state is associated with a set of resources for a scheduling request.

14. The UE of claim 1, wherein the UE operation state is one of multiple UE operation states, each UE operation state being associated with one or more resources.

15. The UE of claim 1, wherein the request is indicated by a scheduling request value.

16. The UE of claim 15, wherein the one or more processors are individually and collectively configured to cause the UE to disable a prohibitive timer for scheduling requests.

17. A network entity for wireless communication, comprising:
one or more memories; and
one or more processors, coupled to the one or more memories, individually and collectively configured to cause the network entity to:
receive a request for a user equipment (UE) to enter a UE operation state that is either a reduced power state or a non-reduced power state; and
transmit an indication to enter the UE operation state or an adjusted UE operation state based at least in part on the request.

18. The network entity of claim 17, wherein the UE operation state is associated with a set of uplink transmission occasions.

19. The network entity of claim 17, wherein the indication includes one or more bits that indicate to remain in a same UE operation state, switch to a first new UE operation state, or switch to a second new operation state.

20. The network entity of claim 17, wherein the indication includes one or more bits that indicate to cancel or extend a reduced power state.

21. The network entity of claim 17, wherein the one or more processors, to receive the request, are individually and collectively configured to cause the network entity to receive the request in multiple transmission stages.

22. The network entity of claim 17, wherein the UE operation state includes a set of UE operation states, and wherein the indication indicates one or more UE operation states.

23. The network entity of claim 22, wherein the request indicates a resource that is associated with the set of UE operation states, and wherein the indication indicates the resource.

24. The network entity of claim 17, wherein the UE operation state is associated with a set of resources for a scheduling request.

25. The network entity of claim 17, wherein the UE operation state is one of multiple UE operation states, each UE operation state being associated with one or more resources.

26. The network entity of claim 17, wherein the request is indicated by a scheduling request value.

27. A method of wireless communication performed by a user equipment (UE), comprising:
selecting a UE operation state that is either a reduced power state or a non-reduced power state; and
transmitting a request to enter the UE operation state.

28. The method of claim 27, further comprising:
receiving an indication to enter the UE operation state or an adjusted UE operation state based at least in part on the request; and
entering the UE operation state or the adjusted UE operation state based at least in part on the indication.

29. The method of claim 27, wherein the reduced power state is configured with resources to transmit a new request to enter a new UE operation state.

30. A method of wireless communication performed by a network entity, comprising:
receiving a request for a user equipment (UE) to enter a UE operation state that is either a reduced power state or a non-reduced power state; and
transmitting an indication to enter the UE operation state or an adjusted UE operation state based at least in part on the request.
